(19) United States
(12) Patent Application Publication
(10) Pub. No.: US 2001/0032336 A1
(43) Pub. Date: Oct. 18, 2001

(54) Broadcast system

(76) Inventors: Jason Kaufman, Scottsdale, AZ (US); Lance Kaufman, Paradise Valley, AZ (US)

Correspondence Address: Squire, Sanders & Dempsey L.L.P., Two Renaissance Square, Suite 2700, 40 North Central Avenue, Phoenix, AR, 85004-4498, US

(21) Appl. No.: 09/792,656

(22) Filed: Feb. 23, 2001

Related U.S. Application Data
(60) Provisional application No. 60/184,361, filed on Feb. 23, 2000.

(51) Int. Cl. H04N 7/173; G06F 13/00

(52) U.S. Cl. 725/115; 725/61; 725/59; 725/97; 707/104.1

(57) ABSTRACT

A system for broadcasting program content via a broadcast transmitter includes one or more sources of a plurality of program content. A scheduling system includes memory storing program content selection rules, a statistical database containing information relevant to programming selection, and a processor operable to utilize said rules to operate on said statistical database to determine program content scheduling. The scheduling system accesses program content in accordance with the determined program content scheduling and causes that programming to be supplied to the transmitter.

### RELATED APPLICATION

This application is copending with and claims the benefit of Provisional Patent Application Serial No. 60/184,361 filed Feb. 23, 2000.

### BACKGROUND OF THE INVENTION

This invention pertains to broadcasting of program content, in general, and the programming of broadcast content in particular.

Currently if an entity such as an individual or group wants to broadcast program content, the entity must buy time on a broadcast channel or use a public access station (radio, television or cable). Each of these methods has inherent shortfalls. Buying time on a broadcast channel can be extremely expensive. While public broadcast has restrictions on commercial use and is only available on cable thus reducing audience.

Broadcasting via the Internet requires large amount of bandwidth at the server to reach a large audience or requires complex multicast systems and agreements with Internet service providers (ISPs) near the edge of the Internet.

### BRIEF DESCRIPTION OF THE DRAWING

The invention will be better understood from a reading of the following detailed description of an embodiment of the invention in conjunction with the drawing figures in which like reference designators are used to identify like elements, and in which:

FIG. 1 is a block diagram of a system in accordance with the invention; and

FIG. 2 is a block diagram of the system of FIG. 1 showing more detail.

### DETAILED DESCRIPTION

A system and method in accordance with the principles of the invention advantageously overcomes the disadvantages inherent in prior broadcasting arrangements. In accordance with the principles of the invention, a broadcasting system provides for dynamic, automatic selection of program content in response to predetermined algorithms that take into account program content user data.

A system in accordance with the invention dynamically selects program content from multiple program content sources and broadcasts the program content in accordance with one or more predetermined algorithms or rules. The algorithms or rules may be established by a system administrator. The selection and acquisition algorithms and rules are based on various predetermined factors. The factors include, but are not limited to user data linked to or associated with a program content stream or file, stream or file size, duration, quality, and comparative extrapolated text data. In addition, the algorithms and rules can be based on external data such as the geographical or demographical origin of program content or target broadcast area and/or target broadcast times. These rules can be modified, added to, changed or deleted at any point in time by the administrator. Rules include triggers that determine when they should be run. Rules can be modified or adaptive to changing conditions resulting from data fluctuations.

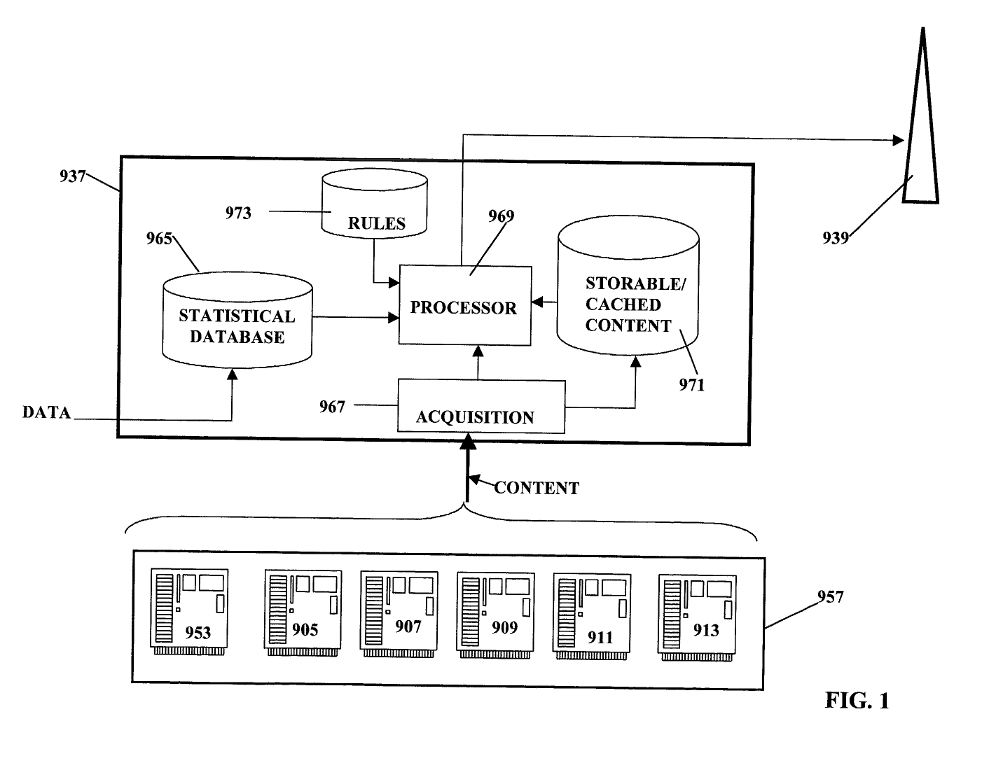

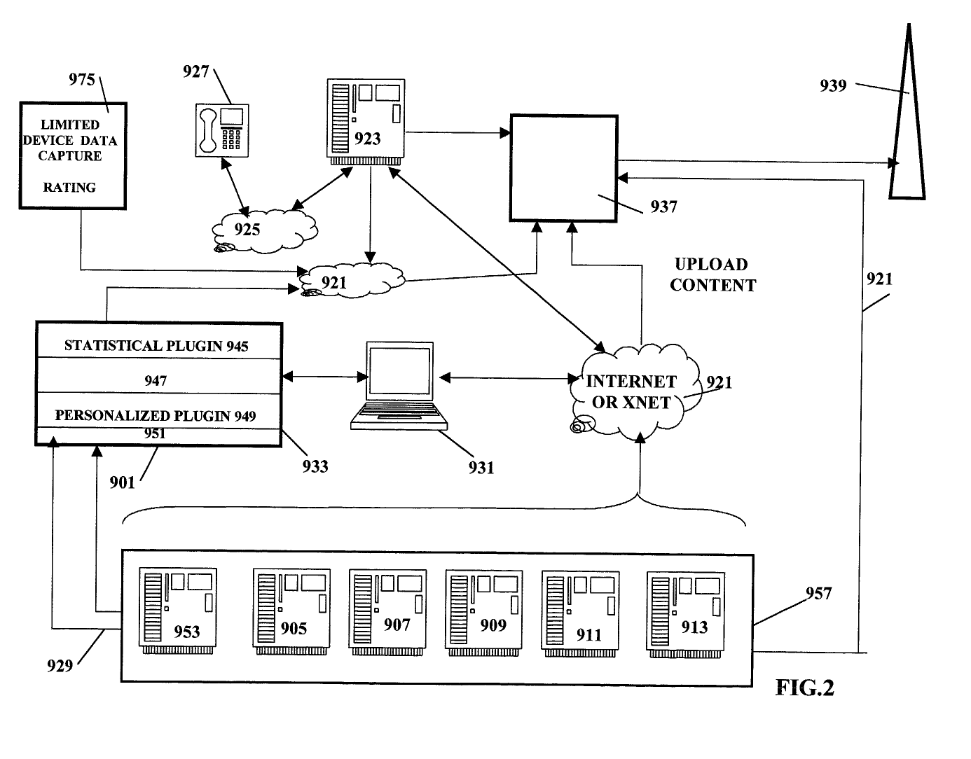

Turning now to the FIGS. 1 and 2, a system in accordance with the invention comprises, a broadcast source 939, program content and controller system 937, and program content sources 957. Broadcast source 939 typically broadcasts program content over a single radio frequency channel. Broadcast source 939 may be any source that broadcasts program content and includes but is not limited to radio broadcasting and television broadcasting.

The term “user” as used herein refers to the consumer of the broadcast program content and typically includes listeners to radio broadcasts and viewers of video broadcasts of program content. User data can be captured by a program content streaming/file server, at the user level or via a separate connection that links program content with the data. This data is transferred to the statistical database 965 where a scheduler processor 969 run its rules and algorithms as stored in memory 973 against the data. User data can be passive collected. Such passive data includes data such as how long a user listened/viewed a program content stream or file, how many links the user executed within that stream or file, and/or what type of program content stream/file was listened to or viewed. User data can also be actively collected. An example of such actively collected data includes user ratings of various attributes of a particular stream/file. For comparative content actual analysis of the audio content is done by extracting text via speech recognition. This text can then be compared with other text extracted from other audio files to determining similar content by thought or keyword mapping.

After processor 969 processes data from memory 965 and applies all applicable rules and algorithms from memory 973, processor 969 acquires and plays selected program content streams from content sources 957. The program content streams or files are provided to a broadcast point transmitter 939. The broadcast point transmitter 939 is a standard AM or FM station for the audio only program content or a broadcast or cable TV station for the video program content. The content is then broadcast. Although only one broadcast point 939 is shown in the drawing figures, the number of broadcast points can be more than one and can be located in geographically distinct areas. Each broadcast point 939 allows the system 939 to use specific usage information from a particular geographical region. Additionally, a personalization option can reside at the user level, which allows the user to personalize an audio or video introduction that is uploaded to system 937 and is used as the introduction to a track or program. An upload feature allows the user to upload audio or video files for rebroadcast.

A user can access a streamed or downloadable audio/video service on an Internet access device 931 coupled to an audio/video player 933 that is used to listen or view an audio or video file. In addition, the service is accessed via a telephony server 923. Audio/video information is transferred over a switched or packetized network 925 to telephone or a videophone 927 for listening or display.

If a media player 933 is used, as the user sends an audio/video program request 901 to program content sources 957, that request is transfer from web access device 931 through an Internet connection 921 to any of the media servers 957. The same, i.e., via Internet connection 921 is used to send the audio/video broadcast content 929 to media player 933.

A plug-in 945 in media player 933 sends statistical data elements information via an Internet or xnet 921 to system 937 for storage in statistical database 965. A server statistical upload software program 959 that resides with media servers 957 can also pass statistical data elements via an Internet or xnet 921 to system 937 for storage in statistical database 965.

Additional plug-in programs can reside at media player 933. A rating system plug ins 947 allows an individual listening or watching a certain feed to qualitatively rank relative aspects of that feed. The resulting statistical data element(s) are sent back to system 937 via Internet connection 921 for storage in statistical database 965.

A personalized plug-in 949 in Media Player 933 permits a user to select and upload an introduction that the user produced for use by system 937 in introducing a new feed. The user uploaded content is uploaded via Internet or xnet 921 and stored in storable/cached content database 971. Other related text based data pertaining to that feed is stored in statistical database 965.

Upload plug-in 951 allows the user to directly upload audio or video files, which can be used for rebroadcast or streamed. The content is uploaded via Internet or xnet 921 and stored in storable/cached content database 971. Other related text based data pertaining to that feed is stored in statistical database 965.

With telephony server 923 statistical data elements, either passive or active, gathered by speech recognition or DTMF commands can be passed via Internet connection 921 to system 937 for storage in statistical database 965. Additional data can be passed to system 937 via a linked device data capture 975. Linked device data capture 975 is a WAP or Internet device that is linked to the content by manual or automatic means. Data is entered on the linked device and passed along to the system 937 via Internet or xnet connection 921 to be stored in statistical database 965.

At system 937, processor 969 takes all the statistical data elements that is received and applies the algorithms and rules from memory 973 and generates a schedule of program content to be broadcast via transmitter 939 via RF in real time. The rules stored in memory 973 are based on various factors such as user data linked to or associated with a content stream or file, stream or file size, duration, quality, and comparative extrapolated text data. Additional rules are based on external data such as content's geographical or demographical origin or target broadcast area and time. The rules can be added, changed or deleted at any point in time by a system administrator. Rules include triggers that determine when they should be run. Processor 969 operating in accordance with algorithms can change the rules or modify them to adapt to changing conditions resulting from data fluctuations. Rules can be entered via computer interface which is not shown.

Content that is going to be output by system 937 comes from a variety of sources including an MP3 or other digital audio streaming server 905, a real web audio server 907, a netshow web server 909, a multimedia streaming server 911 and a server 913 with audio and or video files. Real time program content acquisition, is provided via an Internet or xnet 921 connection as it is being broadcast from a transmitter 939 or comes from content that is being stored inside storable/cached content database 971. The stored/cached content is originally received via an Internet or xnet connection 921. Content in storable/cached content database 971 was either uploaded or acquired at the request of the processor 969 based on a predetermined time or other trigger events.

The system of the invention is a real-time system, in which rules determine what streamed or digitally stored content, is to be broadcast on an RF channel based on administrative rules calculated against data associated with content, content consumers and geographical/time based data. Rules are based on user data linked to or associated with a content stream or file. Stream or file content size, duration, quality, and comparative extrapolated text data can be used in forming the rules. External data such as content's geographical or demographical origin or target broadcast area and time can also be used in forming the rules. User data can be captured by the streaming/file server, at the user level or via a separate connection that manually or automatically links the content with the data. User data can be passive collected. User data includes how long a user listened/viewed a stream or file, how many links they executed within that stream or file, and what type of stream/file was accessed. User data can be actively collected and include user ratings of various attributes of a particular stream/file. Comparative content actual analysis of the audio content is extracted via speech recognition. Speech recognition text can be compared with other text extracted from other audio files to determining similar content by thought or keyword mapping. Content being rebroadcast can originate from either a live or stored source.

The invention has been described in terms of a specific embodiment. It is not intended that the invention be limited to the specific embodiment shown and described. It will be apparent to those skilled in the art that various changes and modifications may be made without departing from the spirit or scope of the invention. It is intended that the invention be limited only by the scope of the claims that are appended hereto.

What is claimed is:

1. A system for broadcasting program content, comprising:
a broadcast transmitter;
one or more sources of a plurality of program content;
a scheduling system, said scheduling system including memory storing program content selection rules, a statistical database containing information relevant to programming selection, and a processor operable to utilize said rules to operate on said statistical database to determine program content scheduling, said scheduling system being operable to access program content in accordance with said determined program content scheduling and to cause said programming to be supplied to said transmitter.

2. A system in accordance with claim 1, wherein:
said information is obtained from system users.
